(19) United States
(12) Patent Application Publication
(10) Pub. No.: US 2022/0368184 A1
(43) Pub. Date: Nov. 17, 2022

(54) ELECTRIC MACHINE

(71) Applicant: GM GLOBAL TECHNOLOGY OPERATIONS LLC, Detroit, MI (US)

(72) Inventors: Song He, Troy, MI (US); Peng Zhang, Rochester, MI (US); Michael C. Muir, Troy, MI (US); Yew Sum Leong, Northville, MI (US)

(21) Appl. No.: 17/317,088

(22) Filed: May 11, 2021

(51) Int. Cl. H02K 1/28; H02K 1/27; H02K 15/02

(52) U.S. Cl. CPC H02K 1/28; H02K 1/276; H02K 15/024; H02K 2213/03; H02K 2201/03; H02K 2201/06

(57) ABSTRACT

An electric machine may include a rotor having a notch at each pole wherein each notch is skewed by some mechanical angle. Notches may fluidly couple one end of the rotor to the other end of the rotor and provide pumping functionality for fluid therein.

### INTRODUCTION

This disclosure is related to rotary electric machines.

Rotary electric machines are found in many industrial and product applications. Electric vehicles, including hybrid electric vehicles, include at least one rotary propulsion motor for producing motive power. Brushless AC motors are a popular choice for propulsion motors. AC motors include a stator including one or more phases of AC power. Typically, AC propulsion motors are polyphase and employ three or more phases of AC power to generate a rotating magnetic field in the stator to drive the motor's rotor.

One exemplary brushless AC motor may include an interior permanent magnet (“IPM”) electric machine having a plurality of electrical steel laminations forming the core structure of the rotor embedded with purposefully-arranged permanent magnets, (e.g., double V-configurations of magnets constructed from neodymium-iron-boron (“NdFeB”), Samarium Cobalt (“SmCo”), ferrite, or another magnetic material having magnetic properties that are well-suited to the application.) Permanent Magnet Synchronous Reluctance Motors (“PM-SRMs”) are also available for applications requiring relatively high-speed operation, power density, and efficiency.

Rotary electric machines are primary sources of radiated noise in many applications, including in electrified powertrains in which one or more electric machines are employed as torque sources, (e.g., as high-voltage propulsion motors.) Such machine noise tends to be most prevalent at dominant winding and torque ripple orders, for instance at three harmonics of a pole pass order for an exemplary three-phase electric machine and torque ripple orders corresponding to number of stator slots. Typical electric and hybrid electric vehicle powertrains tend to skew the rotor or stator in an effort toward minimizing undesirable noise, vibration, and harshness (“NVH”) effects. However, such skewing techniques may have the undesirable effect of reducing overall machine performance and operating efficiency. A similar result may follow from imposition of more stringent NVH constraints in the machine's overall electromagnetic design. A need therefore exists for a more efficient approach to reducing harmonic noise within an electrified powertrain employing a rotary electric machine.

### SUMMARY

In one exemplary embodiment, an electric machine may include a stator, a rotor having first and second ends, an air gap defined between the stator and the rotor, and a notch in the rotor opposing the stator, the notch being skewed along at least a portion of the rotor intermediate the first and second ends of the rotor.

In addition to one or more of the features described herein, the notch may be equivalently distributed on both sides of a q-axis of the rotor.

In addition to one or more of the features described herein, the rotor may include a set of permanent magnets embedded symmetrically within the rotor with respect to the q-axis.

In addition to one or more of the features described herein, the notch in the rotor may include a continuous notch fluidly coupling the first and second ends of the rotor.

In addition to one or more of the features described herein, the notch in the rotor may include a discontinuous notch.

In addition to one or more of the features described herein, the discontinuous notch in the rotor may include a plurality of sub-notches.

In addition to one or more of the features described herein, the sub-notches may be individually not skewed.

In addition to one or more of the features described herein, the sub-notches may be individually skewed.

In addition to one or more of the features described herein, the continuous notch in the rotor may include a plurality of sub-notches.

In addition to one or more of the features described herein, the notch may include tangentially-continuous fillets which smoothly transition the notch into an outer diameter surface of the rotor.

In addition to one or more of the features described herein, the rotor may include a plurality of laminations wherein the plurality of laminations may include no more than three disparate lamination patterns.

In addition to one or more of the features described herein, the rotor may include a plurality of laminations wherein the plurality of laminations may include no more than two disparate lamination patterns.

In addition to one or more of the features described herein, the rotor may include a plurality of laminations wherein the plurality of laminations may include a number of disparate lamination patterns substantially equivalent to the total number of laminations in the portion of the rotor stack corresponding to the longest sub-notch.

In addition to one or more of the features described herein, the notch may be skewed at an angle in a range of greater than 0 degrees and less than about 5 degrees.

In addition to one or more of the features described herein, the notch may be skewed at an angle in a range from about 1 degree to about 2 degrees.

In addition to one or more of the features described herein, the notch may be skewed at an angle in a range from about 3.1 degrees to about 5 degrees.

In addition to one or more of the features described herein, the notch in the rotor may be effective to pump fluid therethrough when the rotor is spinning.

In addition to one or more of the features described herein, the notch in the rotor is formed by machining the notch into a rotor stack.

In another exemplary embodiment, an electric machine may include a stator, a rotor having first and second ends, an air gap defined between the stator and the rotor, and a notch in the rotor opposing the stator, the notch being skewed between the first and second ends of the rotor at an angle in a range from about 1 degree to about 2 degrees and defining a continuous fluid channel between the first and second ends of the rotor.

In yet another exemplary embodiment, an electrified powertrain may include a battery pack and a traction power inverter module (“TPIM”) connected to the battery pack, and configured to change a direct current (“DC”) voltage from the battery pack to an alternating current (“AC”) voltage. The electrified powertrain may also include a rotary electric machine energized by the AC voltage from the TPIM, and including a stator, a rotor having first and second ends, surrounded by the stator, and having an inner diameter surface and an outer diameter surface, wherein the rotor includes a plurality of equally-spaced rotor magnetic poles, a respective notch in the rotor at each of the equally-spaced rotor magnetic poles, each notch opposing the stator and skewed along at least a portion of the rotor intermediate the first and second ends of the rotor, and a rotor shaft connected to and surrounded by the rotor, and configured to rotate about an axis of rotation in conjunction with the rotor when the electric machine is energized. The electrified powertrain may also include a transmission coupled to the rotor shaft and powered by the electric machine.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 illustrates an electrified vehicular powertrain, in accordance with the present disclosure;

FIG. 2 illustrates an exemplary notch configuration, in accordance with the present disclosure;

FIG. 3 illustrates an exemplary pole of a rotor, in accordance with the present disclosure;

FIG. 4A illustrates an isometric view of an embodiment of a stator of an electric machine, in accordance with the present disclosure;

FIG. 4B illustrates a schematic view of the stator of the electric machine shown in FIG. 4A, in accordance with the present disclosure;

FIG. 5 illustrates an isometric view of an embodiment of a stator of an electric machine, in accordance with the present disclosure;

FIG. 6A illustrates an isometric view of an embodiment of a stator of an electric machine, in accordance with the present disclosure;

FIG. 6B illustrates a schematic view of the stator of the electric machine shown in FIG. 6A, in accordance with the present disclosure;

FIG. 7 illustrates an isometric view of an embodiment of a stator of an electric machine, in accordance with the present disclosure;

FIG. 8 illustrates an isometric view of an embodiment of a stator of an electric machine, in accordance with the present disclosure;

FIG. 9 illustrates an isometric view of an embodiment of a stator of an electric machine, in accordance with the present disclosure;

FIG. 10 illustrates a schematic view of an embodiment of a stator of an electric machine, in accordance with the present disclosure;

FIG. 11 illustrates a schematic view of an embodiment of a stator of an electric machine, in accordance with the present disclosure;

FIG. 12 illustrates a schematic view of an embodiment of a stator of an electric machine, in accordance with the present disclosure;

FIG. 13 illustrates a schematic view of an embodiment of a stator of an electric machine, in accordance with the present disclosure;

FIG. 14 illustrates a schematic view of an embodiment of a stator of an electric machine, in accordance with the present disclosure;

FIG. 15 illustrates a schematic view of an embodiment of a stator of an electric machine, in accordance with the present disclosure;

FIG. 16 illustrates a schematic view of an embodiment of a stator of an electric machine, in accordance with the present disclosure;

FIG. 17 illustrates a schematic view of an embodiment of a stator of an electric machine, in accordance with the present disclosure; and

FIG. 18 illustrates a graph of torque ripple versus notch skew angle, in accordance with the present disclosure.

### DETAILED DESCRIPTION

The following description is merely exemplary in nature and is not intended to limit the present disclosure, its application or uses. Throughout the drawings, corresponding reference numerals indicate like or corresponding parts and features.

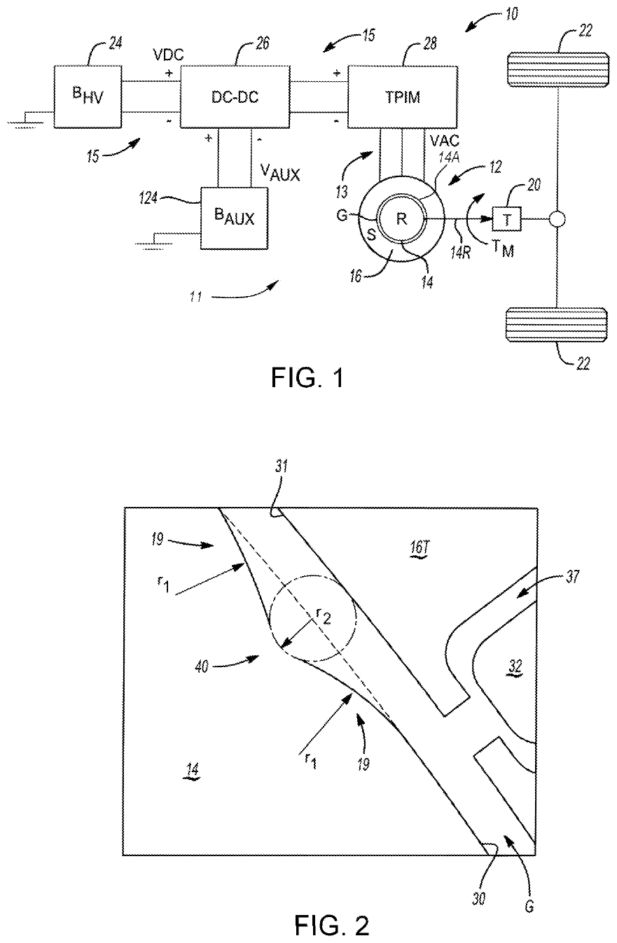

Referring to the drawings, wherein like reference numbers refer to the same or like components in the several Figures, an electrified powertrain 10 is depicted schematically in FIG. 1, (e.g., for use aboard an exemplary motor vehicle 11.) The powertrain 10 includes a rotary electric machine 12 having a rotor assembly 14A and a stator 16.) When the stator 16 is energized, the rotor assembly 14A supplies motor torque (arrow T_{M}) to a transmission (“T”) 20, (e.g., a stepped-gear automatic transmission.) Although omitted for illustrative simplicity, the electrified powertrain 10 may also include an internal combustion engine configured to generate engine torque. When so equipped, the generated engine torque is selectively provided to the transmission 20, either alone or in conjunction with the motor torque (arrow T_{M}) from the electric machine 12.

In order to reduce targeted noise, vibration, and harshness (“NVH”) orders in the electric machine 12, a peripheral outer diameter surface 30 of a rotor 14 of the rotor assembly 14A is modified to define concavities or notches 40 (see FIG. 2) associated with any given rotor pole. As will be appreciated by one having ordinary skill in the art, the electric machine 12 has a direct-axis (“d-axis”) and a quadrature axis (“q-axis”). The disclosed notches are arranged near or with respect to such axes in the manner depicted in the various figures as set forth herein.

When the vehicle 11 of FIG. 1 is embodied as a hybrid electric vehicle, the electric machine 12 and/or the engine may power the transmission 20. Alternatively, the vehicle 11 may be a battery electric vehicle, in which case the transmission 20 may be powered solely by the motor torque (arrow T_{M}) from the electric machine 12. The disclosed improvements relate to the construction of the electric machine 12, and may be realized in hybrid electric vehicle (“HEY”) and electric vehicle (“EV”) embodiments of the vehicle 11 without limitation, as well as in non-vehicular applications such as power plants, hoists, mobile platforms and robots, etc.

The rotor assembly 14A of the electric machine 12 is positioned adjacent to the stator 16 and separated therefrom by an airgap G, with such an airgap G forming a magnetic flux barrier. The stator 16 and the rotor 14 of rotor assembly 14A may be constructed from a stack-up of thin laminations, (e.g., electrical steel or another ferrous material, with each lamination typically being about 0.2 mm-0.5 mm thick as will be appreciated by those of ordinary skill in the art.) The rotor assembly 14A according to a non-limiting exemplary embodiment is arranged concentrically within the stator 16 such that the stator 16 surrounds the rotor assembly 14A. In such an embodiment, the airgap G is a radial airgap and the electric machine 12 embodies a radial flux-type machine. However, other embodiments may be realized in which the relative positions of the rotor assembly 14A and stator 16 are reversed. For illustrative consistency, the embodiment of FIG. 1 in which the rotor assembly 14A resides radially within the stator 16 will be described herein without limiting the construction to such a configuration.

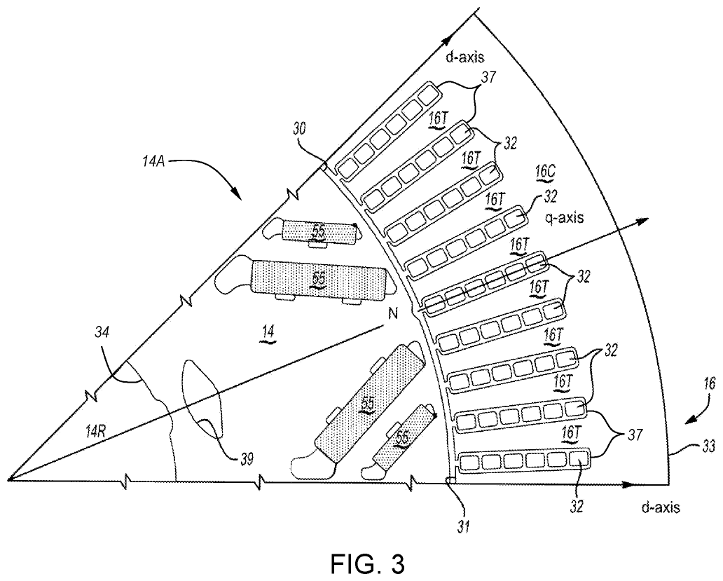

The rotor 14 shown schematically in FIG. 1 optionally includes an embedded set of permanent magnets collectively referred to herein as rotor magnets 55 (see FIG. 3). The electric machine 12 in such an embodiment is an interior permanent magnet (“IPM”) machine, or alternatively a synchronous reluctance machine. The rotor magnets 55 may be constructed, for example, of ferrite, Neodymium-iron-boron, Samarium cobalt, aluminum-nickel-cobalt, etc., or another application-suitable material. The rotor magnets 55 in such embodiment are embedded within the stack of individual steel laminations of the rotor 14. The illustrated configuration of the rotor magnets 55 is exemplary of one embodiment of an IPM machine.

With continued reference to the exemplary vehicle 11 of FIG. 1, the electrified powertrain 10 may include an alternating current (“AC”) voltage bus 13. The AC voltage bus 13 may be selectively energized via a traction power inverter module (“TPIM”) 28 that is direct current (“DC”) coupled to a high-voltage battery pack (“B_{HV}”) 24, for instance a lithium ion, lithium sulfur, nickel metal hydride, or other high-energy voltage supply. The AC voltage bus 13 provides an AC bus voltage (“VAC”) and conducts AC current to or from the electric machine 12. The motor torque (arrow T_{M}) from the energized electric machine 12, when operating in a drive or motoring mode, is imparted to a rotor shaft 14R of the rotor assembly 14A, with the rotor shaft 14R journaled, splined, or otherwise connected to an inner diameter surface 34 (see FIG. 3) of the rotor 14. The motor torque (arrow T_{M}) is then directed to a coupled load, such as the transmission 20 and/or one or more road wheels 22.

The electrified powertrain 10 may also include a DC to DC (“DC-DC”) converter 26 configured to reduce or increase a relatively high DC bus voltage (“VDC”) as needed. The DC-DC converter 26 is connected between the battery pack 24 and the TPIM 28 via positive (+) and negative (−) rails of a corresponding DC voltage bus 15. In some configurations, an auxiliary battery pack (“B_{AUX}”) 124 may be connected to the DC-DC converter 26, with the auxiliary battery pack 124 which may be embodied as a lead-acid battery or a battery constructed of another application-suitable chemistry and configured to store or supply, for example, a 12-15V auxiliary voltage (“V_{AUX}”) to one or more connected auxiliary devices (not shown).

Referring to FIGS. 2 and 3, the stator 16 of FIG. 1 has radially-projecting stator teeth 16T extending inward from a cylindrical stator housing or core 16C (FIG. 3). That is, the stator teeth 16T extend from the stator core 16C, which has an annular outer diameter surface 33. Inner diameter surface 31 of the stator 16 is the radially-innermost surface of the stator teeth 16T facing or opposing the outer diameter surface 30 of the rotor 14 in spaced adjacency to form air gap G (see FIG. 1). Adjacent stator teeth 16T are separated from each other by a corresponding stator slot 37, as will be appreciated by those of ordinary skill in the art. The stator slots 37 enclose electrical conductors, typically copper wires or copper bars/“hairpins”. Such conductors collectively form stator windings 32. A rotating stator magnetic field is generated when the stator windings 32 are sequentially-energized by a polyphase output voltage from the TPIM 28 of FIG. 1. Stator magnetic poles formed from the resulting rotating stator magnetic field interact with rotor poles provided by the various groupings of the rotor magnets 55 to rotate the rotor assembly 14A including the shaft 14R (FIGS. 1 and 3).

The number, type, position, and/or relative orientation of the rotor magnets 55 ultimately influences the magnitude and distribution of magnetic flux in the ferrous materials of the electric machine 12. With reference to FIG. 3, the rotor magnets 55 may be arranged in sets as shown in a generally V-shaped configuration when the rotor 14 is viewed along its axis of rotation. In such a V-configuration, one end of the rotor magnets 55 is closer to the outer diameter surface 30 of the rotor 14 than the other end of the rotor magnets 55. The ends of the rotor magnets 55 closest to outer diameter surface 30 are spaced closer together than are the ends of the rotor magnets 55 located closer to the rotor shaft 14R. Also when viewed axially as in FIG. 3, the rotor magnets 55 may be symmetrically distributed with respect to the q-axis, with a larger first pair of the rotor magnets 55, (e.g., rectangular bar magnets arranged in a dual V-pattern as shown positioned adjacent to the q-axis for a given rotor pole.) The larger first pair of rotor magnets 55 is flanked by a smaller second pair of the rotor magnets 55, which is likewise shown arranged in a dual V configuration.

As shown in the close-up view in FIG. 2, in order to provide the various NVH reduction benefits disclosed herein, the peripheral outer diameter surface 30 of the rotor 14 is modified to define notches 40. The notches 40 are arranged in a symmetrical manner around the rotor 14 with respect to each magnetic pole of the rotor 14, and may have the same or different sizes and/or shapes. Therefore, the illustrated sizes and shapes are exemplary of the present teachings and non-limiting.

With respect to the outer diameter surface 30, each rotor notch 40 has a notch width r₁ and a notch depth r₂, with r₁>r₂ being one embodiment. Other embodiments may be envisioned, however, in which r₁≤r₂, which may have sufficient utility in certain applications. The width r₁ of each notch 40 provides a smooth, tangentially continuous transition to the outer diameter surface 30 of the rotor 14 to reduce stress concentration in the rotor 14. Non-tangential/non-smooth curvatures or other transition profiles may be used in other embodiments as a tradeoff between various considerations, for example NVH benefits and stress/manufacturing simplicity.

FIG. 3 depicts a single magnetic pole of the rotor 14 of rotor assembly 14A. The rotor 14 may define air cavities 39 proximate the rotor shaft 14R, (e.g., to reduce weight, with one such air cavity 39 visible from the perspective of FIG. 3.) As will be appreciated by those of ordinary skill in the art, the depiction in FIG. 3 is representative of an eight-pole embodiment of the rotor 14, with the remaining seven poles being identical to the exemplary pole of FIG. 3 and thus omitted for illustrative simplicity and clarity. The disclosed rotor notches 40 may be used in a wide range of machine configurations, however, including different combinations of rotor poles (e.g., four, six, eight, ten, etc.) and stator slots (e.g., twenty-four, thirty-six, forty-eight, seventy-two, etc.). The eight-pole embodiment of FIG. 3 is therefore non-limiting and illustrative of just one possible configuration.

The rotor notches 40 contemplated herein include, for each rotor pole, an associated notch N that is located proximate the q-axis (“q-axis notch”). Additional pole associated notches, for example located between the q-axis and d-axes, may be provided though not illustrated. Additional notches to notch N may symmetrically flank the q-axis notch N. As used herein, the term “symmetrically flank” refers to being equidistant from the q-axis notch. Thus, one or more additional pairs of symmetrically flanking notches may be used at each rotor pole in other embodiments.

With respect to the surface profile geometry of the rotor notches 40, the size and shape of the notches 40 may be tailored to a given application in order to maximize noise reduction and evenly distribute vibration energy in the electric machine 12 of FIG. 1. Collectively, inclusion of the notches 40 at each rotor pole of the electric machine 12 significantly reduces machine noise without impacting motor torque and efficiency. In various embodiments, the cross-section of notches 40 viewed along the rotor 14 axis of rotation as in FIGS. 2 and 3 may be circular, elliptical, or polynomial arcuate features. Tangentially-continuous fillets 19 as shown in FIG. 2, or another suitable transition profile or contour, may be used with the notches 40 to provide a smooth transition to neighboring “un-notched” areas of the outer diameter surface 30. Such fillets 19 may avoid rotor stress concentration and noise, particularly at higher rotational speeds of the rotor assembly 14A.

Notch alignments with the rotational axis of the rotor wherein the entirety of the notch is at the same circumferential angle of the rotor may exhibit some losses in performance and may not satisfactorily address stator slot orders. In accordance with the present disclosure of adding skewed rotor notches, certain motor orders, such as stator slot orders, may be reduced and NVH benefits enhanced over notches aligned with the rotational axis. The term “skewed” as used herein may be understood to mean a varying circumferential angle as described further herein. Thus, it is understood that a notch that is located proximate the q-axis (i.e. q-axis notch) will not be wholly aligned with the q-axis. In one embodiment, a notch that is proximate the q-axis may be equivalently distributed with respect to the q-axis. Thus, an equivalent amount of notching of the rotor on both sides of the q-axis corresponds to such an embodiment. However, other embodiments may include more notching on one side of the q-axis than on the other side thereof. All notching of a q-axis notch may also be wholly to one side or the other of a q-axis. The term “notch” and “sub-notch” as used herein may be understood to mean a region at the radially-outermost surface of the rotor defined by a rotor material void resulting in a locally enlarged air gap with the adjacent stator. The term “sub-notch” is understood to refer to a notched region that only partially extends axially and is axially adjacent to at least one other notched region that also only partially extends axially. It is understood that notch and sub-notch voids are not permanently filled with ferrous or non-ferrous conductors though such voids may be filled with non-conductive material such as epoxies or varnishes. In one embodiment, the notches and sub-notches remain void of permanent material and open to the air gap such that gaseous and liquid fluids exposed within the air gap may similarly be exposed within the notches. Further, “notch” as used herein may be understood to mean a grouping of two or more sub-notches which may individually be aligned with the rotational axis or skewed yet wherein axially adjacent ones of such sub-notches are together out of alignment with the rotational axis of the rotor or skewed at different angles or discontinuously. In accordance with the present disclosure, a skewed notch may be continuous in so far as the notch defines an unobstructed passage from one end of the rotor to the opposite end of the rotor. Continuous notches that are void of permanent material are therefore understood to fluidly couple one end of the rotor to the other end of the rotor insofar as gaseous and liquid fluids are free to flow between the rotor ends within such continuous notches. Alternatively, a skewed notch may be discontinuous insofar as the notches are at least partially obstructed between one end of the rotor and the opposite end of the rotor. For example, each skewed notch may include a grouping of two or more sub-notches wherein the sub-notches individually and in combination do not define an unobstructed passage from one end of the rotor to the opposite end of the rotor. The concepts of skewing and discontinuity as relates to notches and sub-notches will become clearer in conjunction with further explanation, examples and the figures herein.

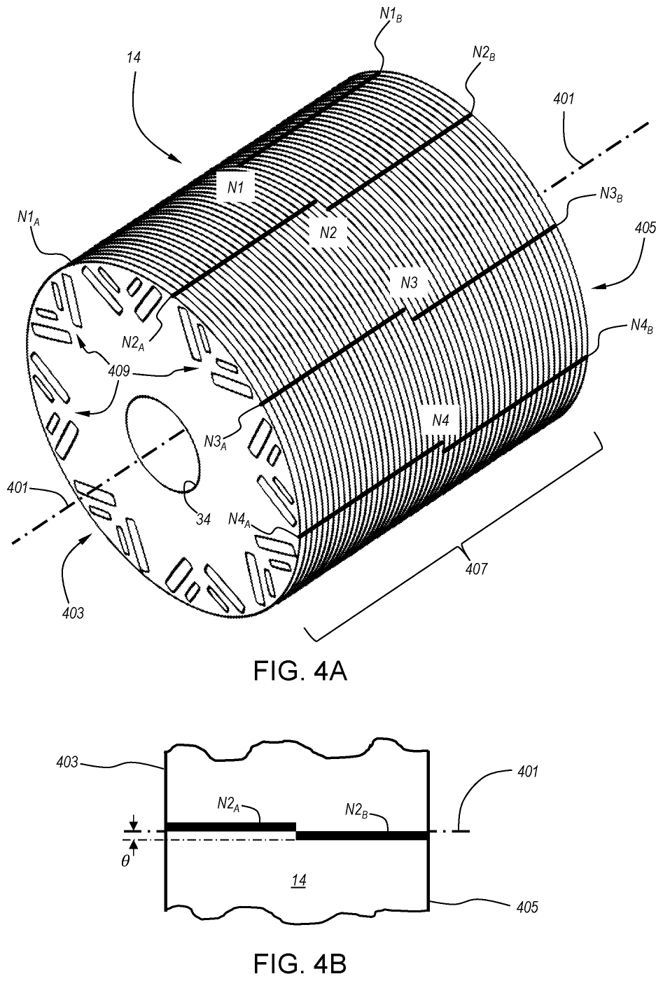

One exemplary embodiment of a discontinuous, skewed notch is illustrated in the detailed isometric view of FIG. 4A and the corresponding simplified schematic view of FIG. 4B. Rotor 14 may be constructed as a stack of substantially cylindrical laminations 407 surrounding the rotational axis 401 of the rotor 14. The rotor 14 may be joined at an inner diameter surface 34 to a rotor shaft (not illustrated) that is coaxial with the rotational axis 401 via a journaled, splined, or other connection. The laminations 407 may include a plurality of interior voids 409 for receiving interior permanent magnets as described with reference to FIG. 3. The rotor 14 includes axially opposite ends 403 and 405. Each notch N1, N2, N3 and N4 includes respective sub-notches A and B designated N1_{A}, N2_{A}, N3_{A}, N4_{A} and N1_{B}, N2_{B}, N3_{B}, N4_{B}. Each notch N1, N2, N3 and N4 is axially discontinuous along rotor 14 at the surface. Each sub-notch N1_{A}, N2_{A}, N3_{A}, N4_{A} and N1_{B}, N2_{B}, N3_{B}, N4_{B} only partially extends axially along rotor 14 at the surface and is thus also axially discontinuous along rotor 14 at the surface. Each individual sub-notch is aligned along a respective circumferential angle and thus is not independently skewed. But all respective groupings of sub-notches N1_{A}/N1_{B}, N2_{A}/N2_{B}, N3_{A}/N3_{B}, and N4_{A}/N4_{B} are out of alignment with a common circumferential angle and are thus skewed. FIG. 4B illustrates schematically a side view of a portion of the rotor 14 including exemplary notch N2 between ends 403 and 405. FIG. 4B illustrates the skewing of the grouping of sub-notches N2_{A}/N2_{B} at some skew angle θ. It is appreciated that each sub-notch N2_{A} and N2_{B} is non-skewed but that the grouping of sub-notches N2_{A}/N2_{B} making up notch N2 is skewed. It is understood that skew angle θ represents a mechanical angle and is not related to electrical angles in machine operation in the present disclosure, however, one having ordinary skill in the art will recognize that mechanical angles may be converted to electrical angles where convenient or beneficial. The sub-notches are illustrated being open at the respective rotor ends, however the sub-notches may also be closed at the rotor ends. It is appreciated that the embodiment shown includes notches wherein corresponding sub-notches occupy only two circumferential angles and thus may be fabricated with only two disparate lamination patterns.

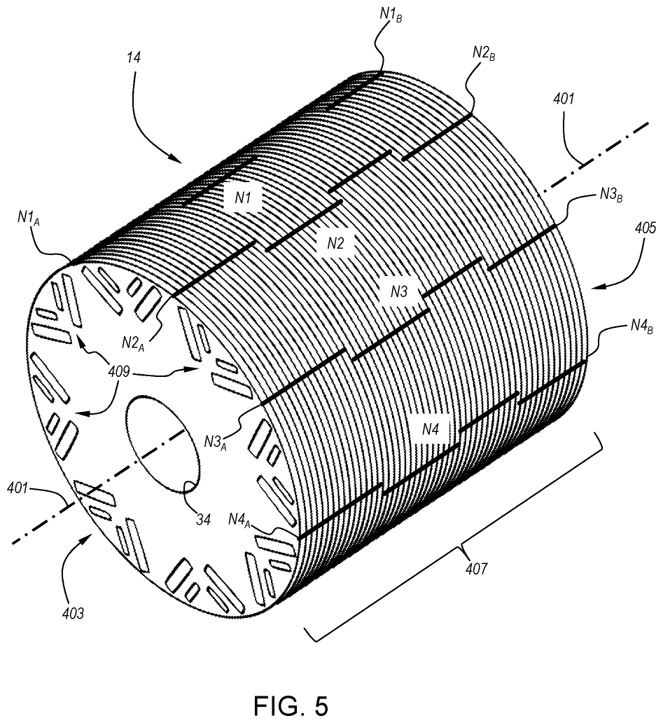

Another exemplary embodiment of a discontinuous, skewed notch is illustrated in the simplified isometric view of a rotor 14 in FIG. 5. Rotor 14 may be constructed as a stack of substantially cylindrical laminations 407 surrounding the rotational axis 401 of the rotor 14. The rotor 14 may be joined at an inner diameter surface 34 to a rotor shaft (not illustrated) that is coaxial with the rotational axis 401 via a journaled, splined, or other connection. The laminations 407 may include a plurality of interior voids 409 for receiving interior permanent magnets as described with reference to FIG. 3. The rotor 14 includes axially opposite ends 403 and 405. Each notch N1, N2, N3 and N4 includes four sub-notches. Each notch N1, N2, N3 and N4 includes respective sub-notches A and B located closest to rotor ends 403 and 405, respectively, and labeled N1_{A}, N2_{A}, N3_{A}, N4_{A} (closest to rotor end 403) and N1_{B}, N2_{B}, N3_{B}, N4_{B} (closest to rotor end 405). Each notch N1, N2, N3 and N4 further includes two additional sub-notches located intermediate the respective sub-notches closest to the ends but not separately labeled for the sake of clarity in FIG. 5. Each notch N1, N2, N3 and N4 is axially discontinuous along rotor 14 at the surface. Each sub-notch only partially extends axially along rotor 14 at the surface and is thus also axially discontinuous along rotor 14 at the surface. Each individual sub-notch is aligned along a respective circumferential angle and thus is not independently skewed. But all respective groupings of sub-notches are out of alignment with a common circumferential angle and are thus skewed. It is understood that skew angle represents a mechanical angle and is not related to electrical angles in machine operation in the present disclosure, however, one having ordinary skill in the art will recognize that mechanical angles may be converted to electrical angles where convenient or beneficial. The sub-notches are illustrated being open at the respective rotor ends, however the sub-notches may also be closed at the rotor ends. It is appreciated that the embodiment shown includes notches wherein corresponding sub-notches occupy only two circumferential angles and thus may be fabricated with only two disparate lamination patterns.

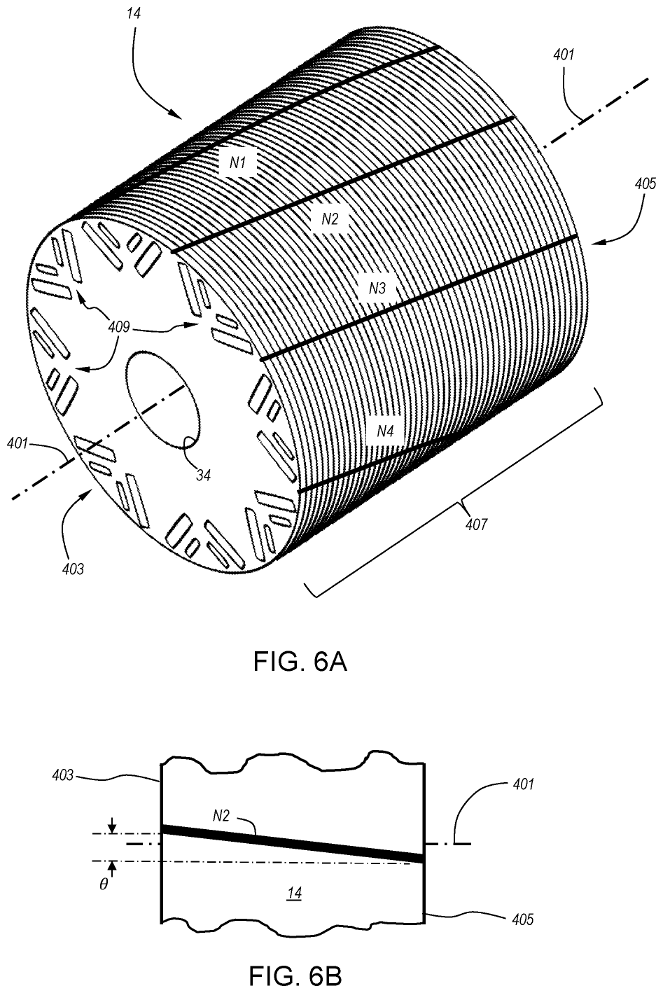

One exemplary embodiment of a continuous, skewed notch is illustrated in the detailed isometric view of FIG. 6A and the corresponding simplified schematic view of FIG. 6B. Rotor 14 may be constructed as a stack of substantially cylindrical laminations 407 surrounding the rotational axis 401 of the rotor 14. The rotor 14 may be joined at an inner diameter surface 34 to a rotor shaft (not illustrated) that is coaxial with the rotational axis 401 via a journaled, splined, or other connection. The laminations 407 may include a plurality of interior voids 409 for receiving interior permanent magnets as described with reference to FIG. 3. The rotor 14 includes axially opposite ends 403 and 405. Each notch N1, N2, N3 and N4 is axially continuous along rotor 14 at the surface and thus provides a channel from one end of the rotor to the other. FIG. 6B illustrates schematically a side view of a portion of the rotor 14 including exemplary notch N2 between ends 403 and 405. FIG. 6B illustrates the skewing of the notch N2 at some skew angle θ which in the present embodiment is measured relative to the ends of the notch as illustrated. It is understood that skew angle θ represents a mechanical angle and is not related to electrical angles in machine operation in the present disclosure, however, one having ordinary skill in the art will recognize that mechanical angles may be converted to electrical angles where convenient or beneficial. The notches are illustrated being open at the respective rotor ends, however the notches may also be closed at the rotor ends wherein such a feature will make the notch discontinuous. It is appreciated that the embodiment shown includes notches wherein fabrication with lamination patterns would require a number of disparate lamination patterns substantially equivalent to the total number of laminations in the rotor stack.

Another exemplary embodiment of a continuous, skewed notch is illustrated in the simplified isometric view of a rotor 14 in FIG. 7. Rotor 14 may be constructed as a stack of substantially cylindrical laminations 407 surrounding the rotational axis 401 of the rotor 14. The rotor 14 may be joined at an inner diameter surface 34 to a rotor shaft (not illustrated) that is coaxial with the rotational axis 401 via a journaled, splined, or other connection. The laminations 407 may include a plurality of interior voids 409 for receiving interior permanent magnets as described with reference to FIG. 3. The rotor 14 includes axially opposite ends 403 and 405. Each notch N1, N2, N3 and N4 includes respective sub-notches A and B designated N1_{A}, N2_{A}, N3_{A}, N4_{A} and N1_{B}, N2_{B}, N3_{B}, N4_{B}. Each notch N1, N2, N3 and N4 is axially continuous along rotor 14 at the surface. Each sub-notch NIA, N2_{A}, N3_{A}, N4_{A} and N1_{B}, N2_{B}, N3_{B}, N4_{B} only partially extends axially along rotor 14 at the surface but joins the adjacent corresponding sub-notch such that together they form an axially continuous notch along rotor 14 at the surface. Therefore, each notch N1, N2, N3 and N4 is axially continuous along rotor 14 at the surface and thus provides a channel from one end of the rotor to the other. Each sub-notch is individually skewed but at a skew angle that is different than the skew angle of the adjacent corresponding sub-notch. It is understood that skew angle represents a mechanical angle and is not related to electrical angles in machine operation in the present disclosure, however, one having ordinary skill in the art will recognize that mechanical angles may be converted to electrical angles where convenient or beneficial. The sub-notches are illustrated being open at the respective rotor ends, however the sub-notches may also be closed at the rotor ends wherein such a feature will make the notch discontinuous. It is appreciated that the embodiment shown includes notches wherein fabrication with lamination patterns would require a number of disparate lamination patterns substantially equivalent to the total number of laminations in the portion of the rotor stack corresponding to the longest sub-notch.

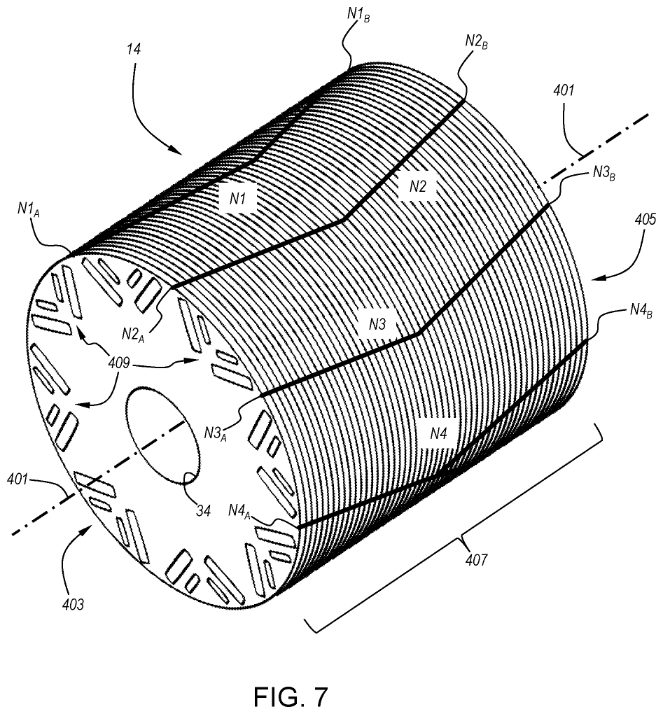

Another exemplary embodiment of a continuous, skewed notch is illustrated in the simplified isometric view of a rotor 14 in FIG. 8. Rotor 14 may be constructed as a stack of substantially cylindrical laminations 407 surrounding the rotational axis 401 of the rotor 14. The rotor 14 may be joined at an inner diameter surface 34 to a rotor shaft (not illustrated) that is coaxial with the rotational axis 401 via a journaled, splined, or other connection. The laminations 407 may include a plurality of interior voids 409 for receiving interior permanent magnets as described with reference to FIG. 3. The rotor 14 includes axially opposite ends 403 and 405. Each notch N1, N2, N3 and N4 includes three sub-notches. Each notch N1, N2, N3 and N4 includes respective sub-notches A and B located closest to rotor ends 403 and 405, respectively, and labeled N1_{A}, N2_{A}, N3_{A}, N4_{A} (closest to rotor end 403) and N1_{B}, N2_{B}, N3_{B}, N4_{B} (closest to rotor end 405). Each notch N1, N2, N3 and N4 further includes one additional sub-notch located intermediate the respective sub-notches closest to the ends but not separately labeled for the sake of clarity in FIG. 8. Each notch N1, N2, N3 and N4 is axially continuous along rotor 14 at the surface. Each sub-notch only partially extends axially along rotor 14 at the surface but joins the adjacent corresponding sub-notch such that together they form an axially continuous notch along rotor 14 at the surface. Therefore, each notch N1, N2, N3 and N4 is axially continuous along rotor 14 at the surface and thus provides a channel from one end of the rotor to the other. Each sub-notch is individually skewed but at a skew angle that is different than the skew angle of the adjacent corresponding sub-notch. The sub-notches closest to the rotor ends are illustrated being open at the respective rotor ends, however the sub-notches may also be closed at the rotor ends wherein such a feature will make the notch discontinuous. It is appreciated that the embodiment shown includes notches wherein fabrication with lamination patterns would require a number of disparate lamination patterns substantially equivalent to the total number of laminations in the portion of the rotor stack corresponding to the longest sub-notch.

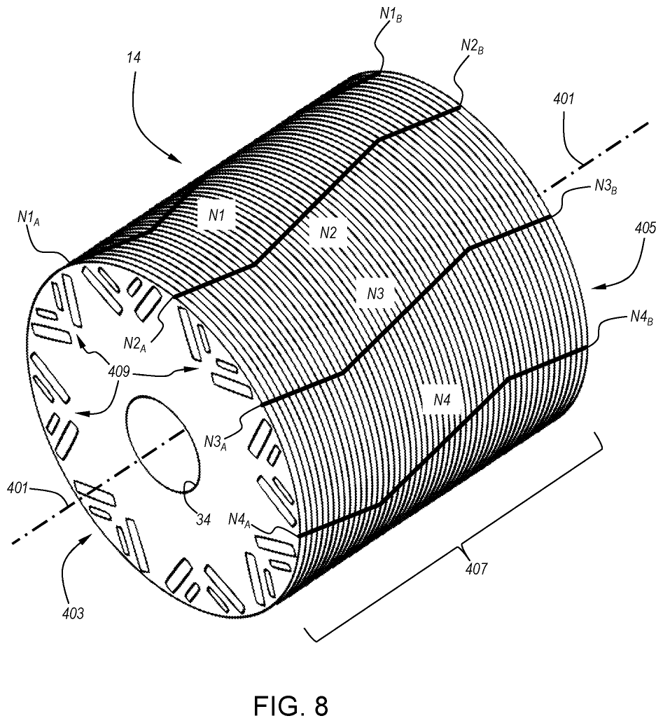

Another exemplary embodiment of a continuous, skewed notch is illustrated in the simplified isometric view of a rotor 14 in FIG. 9. Rotor 14 may be constructed as a stack of substantially cylindrical laminations 407 surrounding the rotational axis 401 of the rotor 14. The rotor 14 may be joined at an inner diameter surface 34 to a rotor shaft (not illustrated) that is coaxial with the rotational axis 401 via a journaled, splined, or other connection. The laminations 407 may include a plurality of interior voids 409 for receiving interior permanent magnets as described with reference to FIG. 3. The rotor 14 includes axially opposite ends 403 and 405. Each notch N1, N2, N3 and N4 includes four sub-notches. Each notch N1, N2, N3 and N4 includes respective equivalent sub-notches A and B located closest to rotor ends 403 and 405, respectively, and labeled N1_{A}, N2_{A}, N3_{A}, N4_{A} (closest to rotor end 403) and N1_{B}, N2_{B}, N3_{B}, N4_{B} (closest to rotor end 405). Each notch N1, N2, N3 and N4 further includes two additional sub-notches located intermediate the respective sub-notches closest to the ends but not separately labeled for the sake of clarity in FIG. 9. Each notch N1, N2, N3 and N4 is axially continuous along rotor 14 at the surface. Each sub-notch only partially extends axially along rotor 14 at the surface but joins the adjacent corresponding sub-notch such that together they form an axially continuous notch along rotor 14 at the surface. Therefore, each notch N1, N2, N3 and N4 is axially continuous along rotor 14 at the surface and thus provides a channel from one end of the rotor to the other. Each sub-notch is individually skewed but at a skew angle that is different than the skew angle of the adjacent corresponding sub-notch. The sub-notches closest to the rotor ends are illustrated being open at the respective rotor ends, however the sub-notches may also be closed at the rotor ends wherein such a feature will make the notch discontinuous. It is appreciated that the embodiment shown includes notches wherein fabrication with lamination patterns would require a number of disparate lamination patterns substantially equivalent to the total number of laminations in the portion of the rotor stack corresponding to the longest sub-notch.

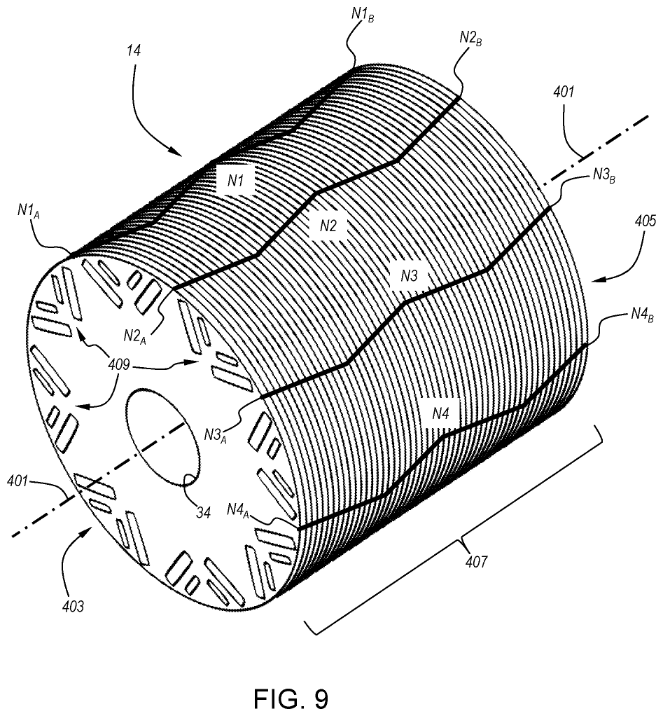

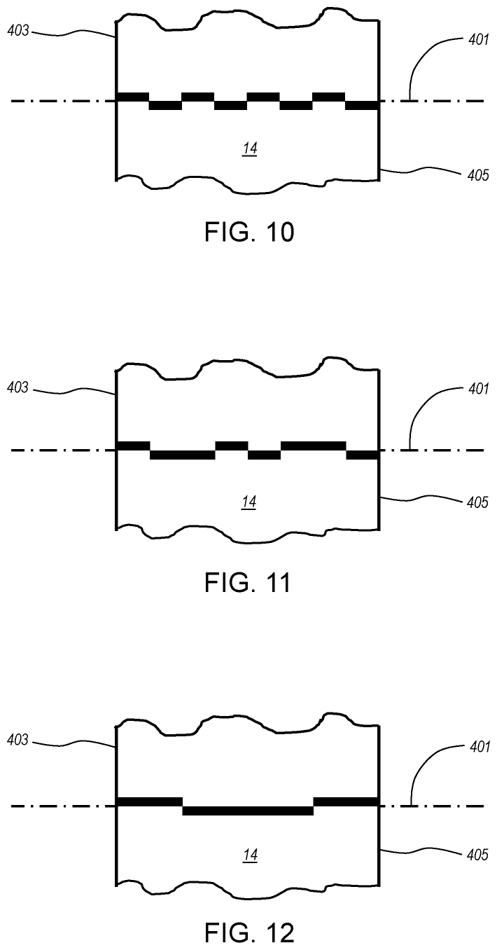

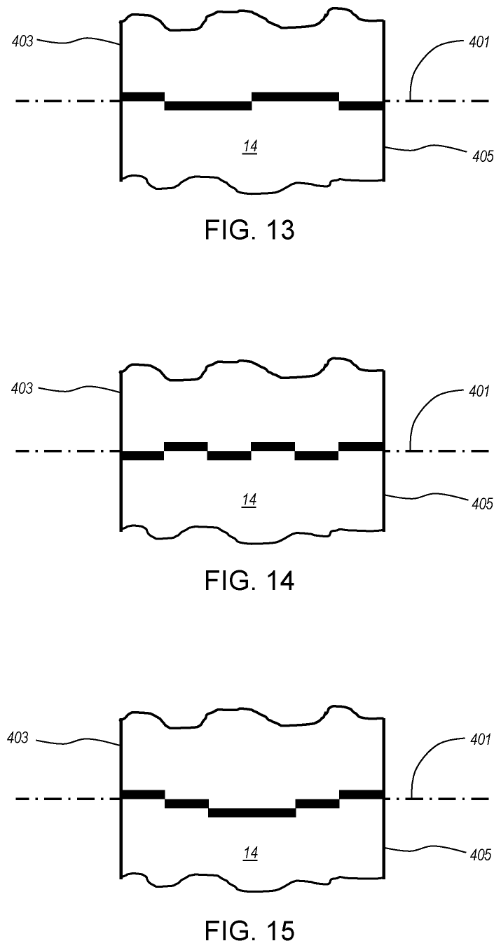

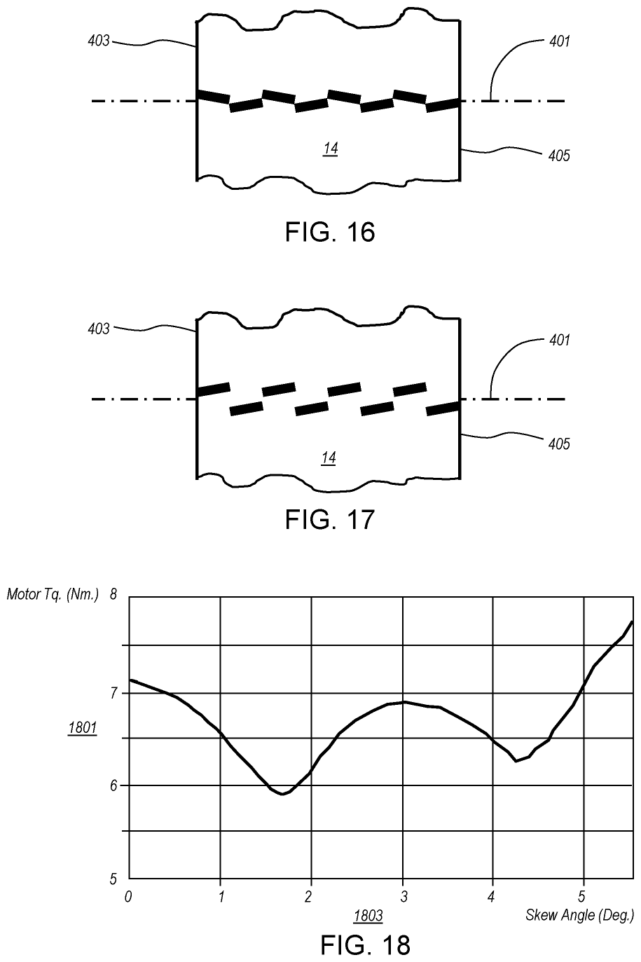

FIGS. 10-17 illustrate various schematic alternative embodiments of discontinuous notches on a rotor 14 as described herein. In all FIGS. 10-17, a side view of a portion of rotor 14 between ends 403 and 405 is illustrated. From FIGS. 10-17 it should be appreciated that none of the illustrated embodiments show continuity in the sub-notches between rotor 14 ends 403 and 405. Sub-notches are illustrated in differing ratios which may be tuned by the designer to achieve various performance objectives and trade-offs. Assuming fabrication of the various embodiments illustrated in FIG. 4-FIG. 17, it is appreciated that the embodiments of FIGS. 4, 5 and 10-14 may be fabricated from just two disparate lamination patterns whereas the embodiments of FIG. 15 would require three disparate lamination patterns. The embodiments of FIGS. 6-9 and 16 and would require a number of disparate lamination patterns substantially equivalent to the total number of laminations in the portion of the rotor stack corresponding to the longest sub-notch. The embodiment of FIG. 17 would require a number of disparate lamination patterns substantially equivalent to the total number of laminations in the two portions of the rotor stack corresponding to the longest two sub-notches having disparate skew angles.

One having ordinary skill in the art will appreciate that notches and sub-notches may vary in accordance with the available design space and constraints including, for example, skew angle magnitude and direction, number of sub-notches, lengths of sub-notches, width, depth and profile of notches, etc. Thus, the illustrated embodiments are to be taken by way of non-limiting examples.

As an alternative to multiple stamped patterns of laminations being assembled to achieve the various embodiments of continuous and discontinuous notches in rotors, machining of assembled rotors may be employed to fabricate any of the various embodiments. A notch profile of material may be removed from an assembled rotor lamination stack to achieve virtually any desired notch pattern. Machining may be performed in fabricating continuous notches. Notch machining may advantageously allow for a single stamped pattern for all laminations in the stack. As used herein, the term “machining” and “machined” are understood to relate to any suitable manufacturing process by which material may controllably removed from a fully or partially assembled rotor stack to define a desired notch profile and may include, as non-limiting examples, mechanical milling and grinding, electrochemical machining, electric discharge machining, and laser beam machining processes.

Continuous notch embodiments may provide a fluid channel from one end of the rotor to the other end of the rotor. Such continuous notch embodiments may provide cooling benefits as gas or liquid cooling mediums may advantageously circulate from one end of the rotor to the other under pressure. Additionally, certain continuous notch embodiments may effectively provide pumping forces on gas and liquid cooling fluids thereby self-circulating such fluids from one end of the rotor to the other during operation. Motor designs that use liquid cooling fluid within the air gap may particularly benefit from continuous notch embodiments which may reduce spin losses particularly at high speed motor operation thereby improving overall machine efficiency.

Torque ripple reduction optimization may be performed for production motors during the development cycle. In at least one optimization case study by the inventors in a 3-phase, 8-pole rotor, 72-tooth stator motor, torque ripple reduction of greater than 15% at 50% rated torque was achieved with an embodiment employing a one-per-pole continuous skewed notch when compared to a one-per pole continuous non-skewed notch. FIG. 18 graphically illustrates torque ripple in Newton-meters along the vertical axis 1801 versus notch skew angle in degrees along the horizontal axis 1803. As may be appreciated in reference to the results illustrated in FIG. 18, any skew angle up to about 5 degrees resulted in torque ripple improvements relative to no skew. A skew angle of approximately 1.7 degrees may result in a local torque ripple optimization. It is appreciated that another local torque ripple optimization may result at a skew angle of approximately 4.3 degrees. Therefore, as can be appreciated from the results illustrated in FIG. 18, one range for skew angle may be between about 0 degrees and about 5 degrees. Another range for skew angle may be between about 0 degrees and about 3.1 with a more particular range of about 1 degree to about 2 degrees. Another more particular range for skew angle may be between about 3.1 degrees and about 5 degrees with an even more particular range of about 4 degrees to about 5 degrees.

Skew angle may be tuned or optimized to achieve various NVH, torque ripple, efficiency, cooling and pumping performance objectives and balance such objectives through tradeoffs among various objectives.

All numeric values herein are assumed to be modified by the term “about”, whether or not explicitly indicated. For the purposes of the present disclosure, ranges may be expressed as from “about” one particular value to “about” another particular value. The term “about” generally refers to a range of numeric values that one of skill in the art would consider equivalent to the recited numeric value, having the same function or result, or reasonably within manufacturing tolerances of the recited numeric value generally.

Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An electric machine, comprising:
a stator;
a rotor having first and second ends;
an air gap defined between the stator and the rotor; and
a notch in the rotor opposing the stator, the notch being skewed along at least a portion of the rotor intermediate the first and second ends of the rotor.

2. The electric machine of claim 1, wherein the notch is equivalently distributed on both sides of a q-axis of the rotor.

3. The electric machine of claim 2, wherein the rotor includes a set of permanent magnets embedded symmetrically within the rotor with respect to the q-axis.

4. The electric machine of claim 1, wherein the notch in the rotor comprises a continuous notch fluidly coupling the first and second ends of the rotor.

5. The electric machine of claim 1, wherein the notch in the rotor comprises a discontinuous notch.

6. The electric machine of claim 5, wherein the discontinuous notch in the rotor comprises a plurality of sub-notches.

7. The electric machine of claim 6, wherein the sub-notches are individually not skewed.

8. The electric machine of claim 6, wherein the sub-notches are individually skewed.

9. The electric machine of claim 4, wherein the continuous notch in the rotor comprises a plurality of sub-notches.

10. The electric machine of claim 1, wherein the notch comprises tangentially-continuous fillets which smoothly transition the notch into an outer diameter surface of the rotor.

11. The electric machine of claim 7, wherein the rotor comprises a plurality of laminations wherein the plurality of laminations comprises no more than three disparate lamination patterns.

12. The electric machine of claim 7, wherein the rotor comprises a plurality of laminations wherein the plurality of laminations comprises no more than two disparate lamination patterns.

13. The electric machine of claim 9, wherein the rotor comprises a plurality of laminations in a rotor stack wherein the plurality of laminations comprises a number of disparate lamination patterns substantially equivalent to a total number of laminations in a portion of the rotor stack corresponding to a longest sub-notch.

14. The electric machine of claim 1, wherein the notch is skewed at an angle in a range of greater than 0 degrees and less than about 5 degrees.

15. The electric machine of claim 1, wherein the notch is skewed at an angle in a range from about 1 degree to about 2 degrees.

16. The electric machine of claim 1, wherein the notch is skewed at an angle in a range from about 3.1 degrees to about 5 degrees.

17. The electric machine of claim 4, wherein the notch in the rotor is effective to pump fluid therethrough when the rotor is spinning.

18. The electric machine of claim 4, wherein the notch in the rotor is formed by machining the notch into a rotor stack.

19. An electric machine, comprising:
a stator;
a rotor having first and second ends;
an air gap defined between the stator and the rotor; and
a notch in the rotor opposing the stator, the notch being skewed between the first and second ends of the rotor at an angle in a range from about 1 degree to about 2 degrees and defining a continuous fluid channel between the first and second ends of the rotor.

20. An electrified powertrain comprising:
a battery pack;
a traction power inverter module (“TPIM”) connected to the battery pack, and configured to change a direct current (“DC”) voltage from the battery pack to an alternating current (“AC”) voltage;
a rotary electric machine energized by the AC voltage from the TPIM, and comprising:
a stator;
a rotor having first and second ends, surrounded by the stator, and having an inner diameter surface and an outer diameter surface, wherein the rotor includes a plurality of equally-spaced rotor magnetic poles;
a respective notch in the rotor at each of the equally-spaced rotor magnetic poles, each notch opposing the stator and skewed along at least a portion of the rotor intermediate the first and second ends of the rotor; and
a rotor shaft connected to and surrounded by the rotor, and configured to rotate about an axis of rotation in conjunction with the rotor when the electric machine is energized; and
a transmission coupled to the rotor shaft and powered by the electric machine.
